(19) United States
(12) Patent Application Publication
(10) Pub. No.: US 2015/0074293 A1
(43) Pub. Date: Mar. 12, 2015

(54) INFORMATION PROCESSING SYSTEM, STORAGE DEVICE AND CONTROLLING METHOD OF STORAGE DEVICE

(71) Applicant: Kabushiki Kaisha Toshiba, Minato-ku (JP)

(72) Inventor: Yuki NAGATA, Yokohama-shi (JP)

(73) Assignee: Kabushiki Kaisha Toshiba, Minato-ku (JP)

(21) Appl. No.: 14/203,945

(22) Filed: Mar. 11, 2014

Related U.S. Application Data
(60) Provisional application No. 61/875,869, filed on Sep. 10, 2013.

(51) Int. Cl. G06F 3/06

(52) U.S. Cl. CPC G06F 3/0659; G06F 3/0604; G06F 3/0673
USPC 710/5

(57) ABSTRACT

According to one embodiment, a storage device includes an internal bus with which a host interface and a controller are connected based on full-duplex communication. The host interface includes a command processing unit that issues the command to the controller. A response to a first command from the controller and an issuance of a second command by the command processing unit are transmitted in parallel, the first command being issued to the controller from the command processing unit.

### CROSS-REFERENCE TO RELATED APPLICATIONS

This application is based upon and claims the benefit of priority from U.S. Provisional Application No. 61/875,869, filed on Sep. 10, 2013; the entire contents of which are incorporated herein by reference.

### FIELD

Embodiments described herein relate generally to an information processing system, a storage device, and a controlling method of a storage device.

### BACKGROUND

In a general information processing system, a host CPU (Central Processing Unit) is connected to a storage device that uses a NAND flash memory (hereinafter referred to as a NAND memory) as a storage medium via a host bus adapter (hereinafter referred to as an HBA). The host CPU controls the HBA via a system memory structure storing content of a command, and an HBA memory register indicating a position in the system memory structure. An advanced host controller interface (AHCI) standard defines an HBA that communicates with a SATA (Serial Advanced Technology Attachment) device.

Conventionally, communication is performed in accordance with a SATA protocol between the AHCI that is one example of an HBA and a storage device. The SATA is a standard for connecting a storage device to a host CPU with a signal from a transmission unit (TX) and a reception unit (RX). However, there is a dependent relation between the transmission unit and the reception unit, and communication is performed in conformity to a half-duplex protocol that operates in a handshaking manner. Therefore, there arises a problem that, when data is carried on the transmission unit, data is not carried on the reception unit. Since the transmission unit and the reception unit operate as a set in a handshaking manner, the collision by the start of the host CPU and the start of the storage device might occur, and hence, a loss such as an arbitration and repetition of various processes preceding a beginning of transmission might be caused.

### BRIEF DESCRIPTION OF THE DRAWINGS

FIG. 1 is a diagram schematically illustrating a configuration of an information processing system according to a comparative example;

FIG. 2 is a sequence diagram illustrating one example of a procedure when a write command and a read command are continuously issued from the information processing system according to the comparative example;

FIG. 3 is a block diagram schematically illustrating one example of a configuration of an information processing system including a storage device according to an embodiment;

FIG. 4 is a diagram illustrating one example of a system memory structure;

FIG. 5 is a block diagram schematically illustrating a configuration of a host interface according to the embodiment; and

FIG. 6 is a sequence diagram illustrating one example of a procedure of a data controlling method in the information processing system according to the embodiment.

### DETAILED DESCRIPTION

In general, according to one embodiment, an information processing system including a host device and a storage device is provided. The storage device includes a host interface that communicates with the host device, a non-volatile storage unit, a controller that performs a data transfer between the host interface and the storage unit, and an internal bus with which the host interface and the controller are connected based on full-duplex communication. The host interface includes a command processing unit that issues the command to the controller, when an instruction of issuing the command is received from the host device. A response to a first command from the controller and the issuance of a second command by the command processing unit are transmitted in parallel, the first command being issued to the controller from the command processing unit.

An exemplary embodiment of an information processing system, a storage device, and a controlling method of a storage device will be explained below in detail with reference to the accompanying drawings. The present invention is not limited to the following embodiment. In the description below, after a configuration and operation of an information processing system according to a comparative example are described, a configuration and an operation of a storage device and an information processing system including the storage device according to the embodiment will be described.

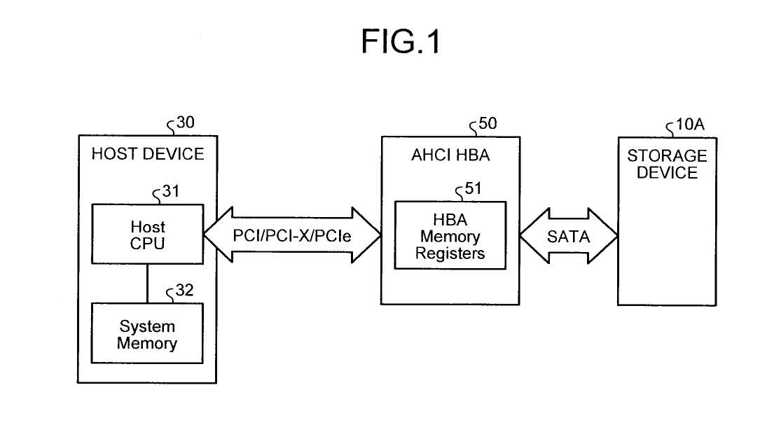

FIG. 1 is a diagram schematically illustrating a configuration of an information processing system according to a comparative example. In the information processing system according to the comparative example, a storage device 10A is a storage device including a non-volatile memory such as a NAND memory as a storage medium, and it is connected to a host device (hereinafter referred to as a host) 30 via an HBA 50.

The host 30 includes a host CPU 31 and a system memory 32. The host CPU 31 controls the whole information processing system. In the embodiment, the host CPU 31 issues a command for writing data to the storage device 10A or for reading data from the storage device 10A.

The system memory 32 has a system memory structure in which information used by the host CPU 31 is stored, and information about content of a command that is to be issued to the storage device 10A is stored. The system memory structure includes a command list that describes a detail of the command to be issued to the storage device 10A from the host CPU 31, and command response information that describes a response returned from the storage device 10A by the execution of the command. The command list and the command response information respectively correspond to a command list structure and a Received FIS structure according to AHCI standard.

The HBA 50 includes an HBA memory register 51 that instructs a storing position of information in the system memory 32 in the host 30. The host 30 and the HBA 50 are connected with PCI (Peripheral Component Interconnect), PCI-X, or PCIe (PCI express) (hereinafter collectively referred to as PCI standard), while the HBA 50 and the storage device 10A are connected with SATA.

The AHCI standard defines that the host CPU 31 and the HBA 50 are connected according to PCI standard. The AHCI standard also defines a method of controlling the storage device 10A via the HBA 50 with a SATA protocol. According to such definition, the host CPU 31 controls the HBA 50 by using the HBA memory register 51 and the system memory structure in the system memory 32 as an interface.

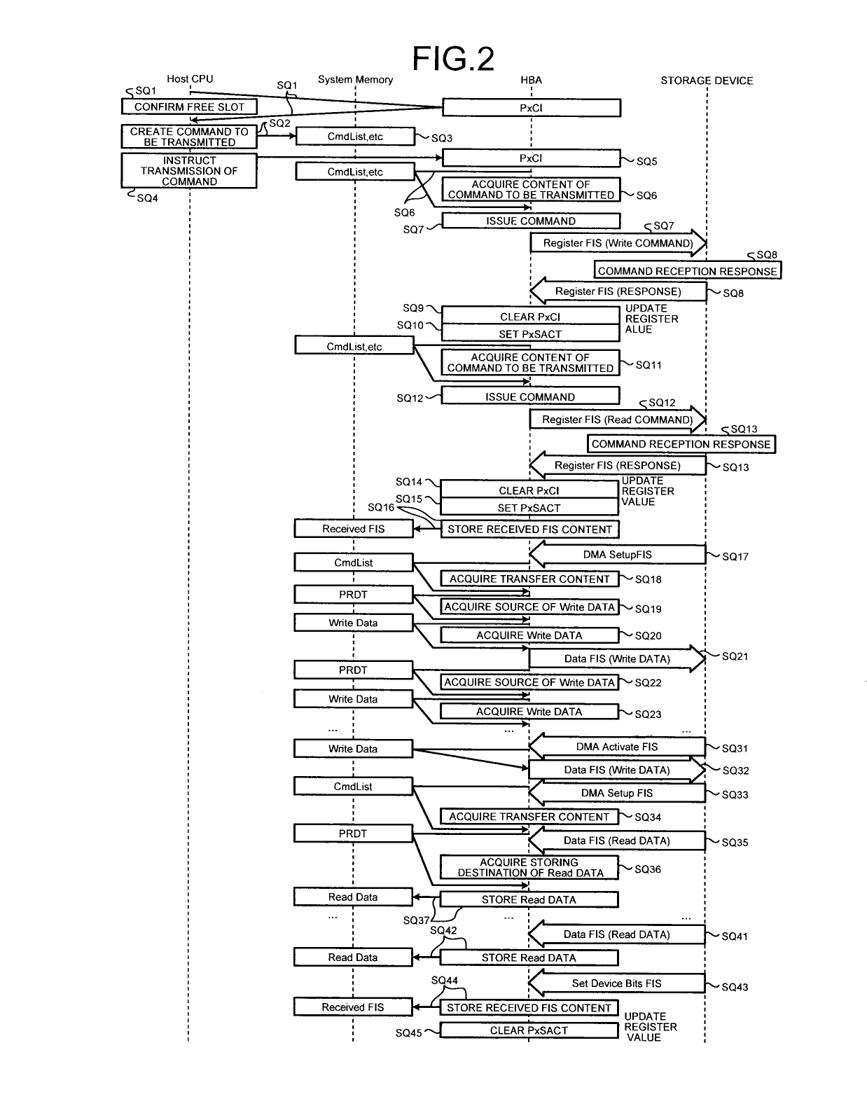

FIG. 2 is a sequence diagram illustrating one example of a procedure when an NCQ write command and an NCQ read command are continuously issued from the information processing system according to the comparative example. The host CPU 31 in the host 30 firstly confirms whether the HBA memory register 51 in the HBA 50 has a free slot or not (SQ1). When it has a free slot, the host CPU 31 creates a command to be issued (SQ2), and registers the created command in the command list in the system memory 32 (SQ3). It is supposed here that plural commands are registered in the command list in the order of an NCQ write command and an NCQ read command.

Then, the host CPU 31 issues an instruction of issuing the command to the HBA 50 (SQ4). With this process, a status of each of the commands to wait for the beginning of the execution is set on a PxCI register (SQ5). For example, a status of the write command to wait for the beginning of the execution is set on one P0CI register, and a status of the read command to wait for the beginning of the execution is also set on the P0CI register.

Then, the HBA 50 refers to the HBA memory register 51 for the set PxCI register, thereby acquiring content of the write command that is to be transmitted based on the command list stored on a predetermined position of the system memory 32 (SQ6). The HBA 50 then transmits a Register FIS (write command) including the write command to the storage device 10A (SQ7).

The storage device 10A receiving the Register FIS (write command) transmits a Register FIS (response) indicating that the Register FIS (write command) is normally received to the HBA 50 (SQ8). Thus, a bit of the PxCI register corresponding to the write command is cleared (SQ9). Further, a PxSACT register indicating the execution state of the write command is set (SQ10).

In addition, the HBA 50 refers to the HBA memory register 51 for the set PxCI register, thereby acquiring content of the read command that is to be transmitted based on the command list stored on a predetermined position of the system memory 32 (SQ11). Then, the HBA 50 transmits a Register FIS (read command) including the read command to the storage device 10A (SQ12).

The storage device 10A receiving the Register FIS (read command) transmits a Register FIS (response) indicating that the Register FIS (read command) is normally received to the HBA 50 (SQ13). Thus, a bit of the PxCI register corresponding to the read command is cleared (SQ14). Further, a PxSACT register indicating the execution state of the read command is set (SQ15). Thereafter, the HBA 50 stores the content of the FIS which is received in the corresponding Received FIS structure in the system memory structure (SQ16). In this example, the content of the FIS which is received is also stored when the Register FIS (response) to the Register FIS (write command) is received in SQ8, although this is not illustrated. In other words, the Register FIS (response) is stored twice in total.

Next, the storage device 10A transmits a DMA Setup FIS including a parameter necessary for DMA transfer of write data to the host CPU 31 (SQ17). When receiving the DMA Setup FIS, the HBA 50 acquires the transfer content of the corresponding write command based on the command list in the system memory 32 (SQ18), and also acquires the source from which the write data is acquired from PRDT (Physical Region Descriptor Table) (SQ19). Here, the PRDT stores the address (the source from which data is acquired) of the data, which is to be written on the storage device 10A, in the system memory 32, in the case of the write command, and stores the address (destination on which data is to be stored) of the data, read from the storage device 10A, in the system memory 32, in the case of the read command.

The HBA 50 acquires write data from the acquired transfer content and the source from which the write data is to be acquired (SQ20), and transmits Data FIS (write data) including the write data to the storage device 10A (SQ21).

Thereafter, the HBA 50 repeatedly executes the processes in SQ19 to SQ21 until the data writing process designated by the transfer content in SQ18 is finished (SQ22 to SQ23). Here, write data is queued in a queuing buffer in the storage device 10A, and the queued data is written on the non-volatile memory, for example.

Then, the storage device 10A transmits DMA Activate FIS to the host CPU 31 (SQ31), the HBA 50 acquires corresponding write data from the system memory 32, and the HBA 50 transmits Data FIS including the acquired data to the storage device 10A (SQ32). Thus, the write command that is the first command is ended.

Thereafter, the storage device 10A transmits DMA Setup FIS including a parameter necessary for DMA transfer of the read data to the host CPU 31 (SQ33). When receiving the DMA Setup FIS, the HBA 50 acquires the transfer content corresponding to the read command based on the command list in the system memory 32 (SQ34). Then, the storage device 10A transmits the Data FIS (read data) including the read data to the HBA 50 (SQ35).

The HBA 50 acquires the storing destination of the read data from the PRDT in the command list in the system memory 32 (SQ36). When receiving the Data FIS (read data), the HBA 50 stores the acquired read data in the system memory 32 based on the acquired transfer content and the storing destination of the data (SQ37).

Thereafter, the HBA 50 repeatedly executes the processes in SQ35 to SQ37 until the data reading process designated by the transfer content is finished (SQ41 to SQ42). Here, read data which is read from the non-volatile memory is queued in the queuing buffer in the storage device 10A, and the queued data is stored in the system memory 32 in the host device 30, for example. Thus, the read command that is the second command is ended.

HBA 50 transmits the last read data to the host CPU 31 (SQ42). Also, the storage device 10A transmits Set Device Bits FIS indicating that the write command and the read command instructed in SQ4 are normally ended to the HBA 50 (SQ43). The HBA 50 stores the content of the FIS which is received into the system memory 32 (SQ44), clears the PxSACT register corresponding to the execution of the write command and the read command (SQ45). Thus, the process is ended.

According to the SATA standard, the process is executed between the HBA 50 and the storage device 10A in a handshaking manner. Therefore, when a certain command is executed, the execution of another command is prevented until this command is ended. Specifically, the transmission path between the HBA 50 and the storage device 10A is constructed to perform half-duplex communication. For example, in FIG. 2, the write command and the read command cannot simultaneously be executed. After the write command is ended, the read command is executed. As described above, the SATA protocol between the HBA 50 and the storage device 10A prevents high-speed processing.

The information processing system, the storage device, and the data controlling method according to the present embodiment will be described below.

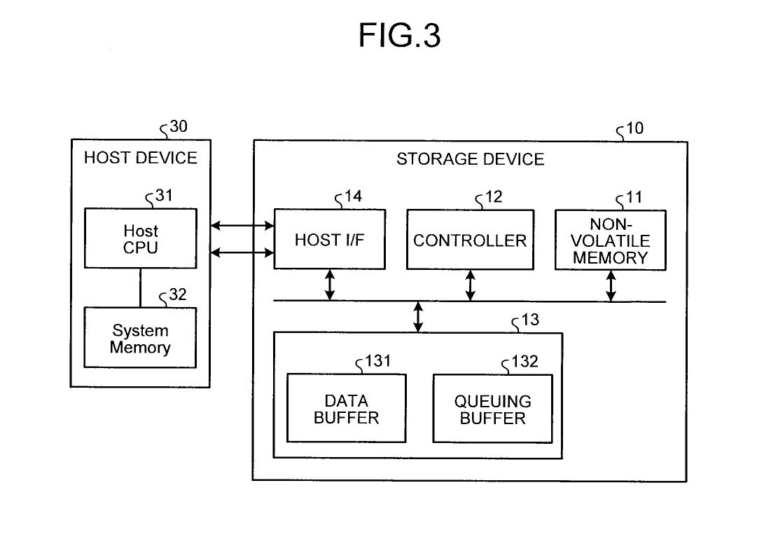

FIG. 3 is a block diagram schematically illustrating one example of a configuration of an information processing system including a storage device according the embodiment. The information processing system includes a host 30 and a storage device 10. The host 30 and the storage device 10 communicate with each other according to PCI standard.

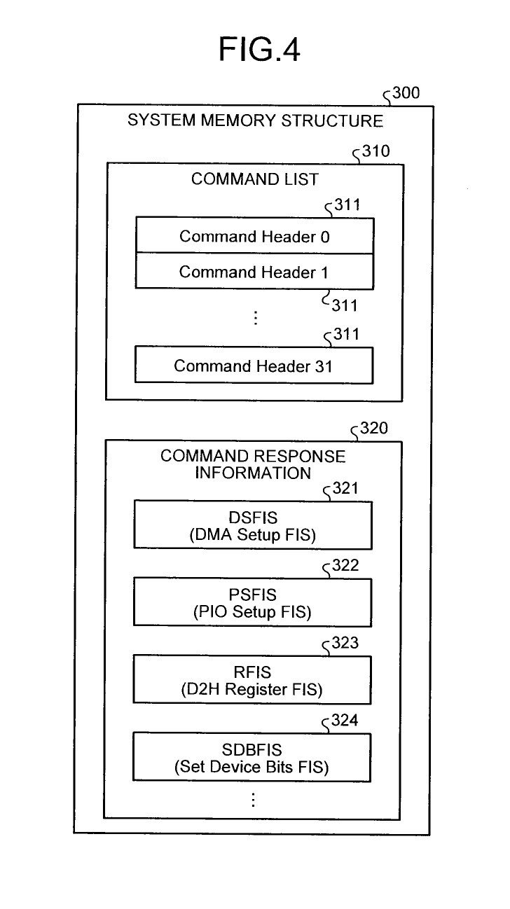

The host 30 includes a host CPU 31 and a system memory 32. The system memory 32 has a system memory structure in which information used by the host CPU 31 is stored, and information about content of a command that is to be issued to the storage device 10 is stored. FIG. 4 is a diagram illustrating one example of the system memory structure. The system memory structure 300 includes a command list 310 that describes information indicating the storing position of the command, a detail of the command to be issued to the storage device 10 from the host CPU 31, and command response information 320 that describes a state of the storage device 10 to the command issued from the storage device 10. The command list 310 and the command response information 320 respectively correspond to a command list structure and a Received FIS structure according to AHCI standard.

The command list 310 includes command headers 311. Each command header 311 has a storing position of the command table on which the detail of the command is written. The command table stores information including a command FIS and PRDT. The command FIS stores the command used with SATA protocol according to a format prescribed by SATA. As described above, in the case of the write command, the PRDT includes a storing address of data, which is to be written on the storage device 10, in the system memory 32, and in the case of the read command, it includes the storing address of data, which is to be read from the storage device 10, in the system memory 32.

The command response information 320 includes DMA Setup FIS (DSFIS) 321, PIO Setup FIS (PSFIS) 322, Register FIS (RFIS) 323, and Set Device Bits FIS (SDBFIS) 324. These are contents prescribed in SATA.

The DMA Setup FIS 321 includes an information necessary for the DMA transfer of data. The DMA transfer is performed based on the DMA Setup FIS 321. The PIO Setup FIS 322 includes an information necessary for PIO transfer of data. The PIO transfer is performed based on the PIO Setup FIS 322.

The Register FIS 323 is information necessary for transmitting error information or status information from the storage device 10 to the host 30.

The Set Device Bits FIS 324 is information for giving notification of error information or status information to the host 30 from the storage device 10 upon the end of the data transfer.

According to the SATA standard, the command response information 320 in the system memory structure 300 is the response (each of the above-mentioned FISs) returned from the storage device 10 to the command issued from the HBA 50 as illustrated in FIG. 2, and the content of the response is registered to the system memory 32 by the HBA 50. However, in the present embodiment, the function of the HBA 50 is given to the host interface 14 in the storage device 10, and the communication according to the SATA standard is not performed in the storage device 10, as described later. Therefore, the storage device 10 does not return each of the above-mentioned FISs to the command issued from the HBA. In the present embodiment, the command response information is written in the system memory structure 300 by the host interface 14 in the storage device 10 on a predetermined timing.

The storage device 10 includes a non-volatile memory 11, a controller 12, a buffer 13, and the host interface 14, which are interconnected with an internal bus 15.

The non-volatile memory 11 stores user data transmitted from the host 30, management information of the storage device 10, system data, and the like. The non-volatile memory 11 is composed of a NAND memory, for example. The NAND memory includes a memory cell array having memory cells arranged in a matrix. The individual memory cell can perform multi-valued storage by using an upper page and a lower page. The NAND memory includes memory chips, wherein each memory chip is configured by arraying physical blocks, which are units of data erasure. In the NAND memory, data is written and read for each physical page. The physical block includes physical pages.

The controller 12 transmits and receives a command or data to and from the host 30 via the host interface 14, and executes various processes, such as a writing process or reading process, to the non-volatile memory 11 based on the host command.

The buffer 13 temporarily stores write data from the host 30 and read data from the non-volatile memory 11. The buffer 13 includes a data buffer 131 and a queuing buffer 132. Stored data is extracted from the data buffer 131 in the order in which the data is stored. Stored data is extracted from the queuing buffer 132 after being rearranged in a predetermined order. In the present embodiment, the data stored in the queuing buffer 132 is data to an NCQ (Native Command Queuing) write command and an NCQ read command, and data to the other commands is stored in the data buffer 131.

The host interface 14 is connected to the host 30 with PCI standard. The host interface 14 operates in accordance with AHCI standard and SATA standard with respect to the host 30, and performs communication with the non-volatile memory 11, connected with the internal bus 15, according to a unique standard without conforming to the SATA standard.

The internal bus 15 is a transmission path that enables transmission of signals (information) among each of the units in the storage device 10. In the present embodiment, the internal bus 15 includes at least a path exclusively used for outgoing direction and a path exclusively used for incoming direction to enable full-duplex communication. A path exclusively used for a command and a path exclusively used for data may be provided in the internal bus, and the path exclusively used for data may include a path exclusively used for outgoing direction and a path exclusively used for incoming direction. In this case, the path exclusively used for a command may be configured to enable half-duplex communication, or to enable full-duplex communication.

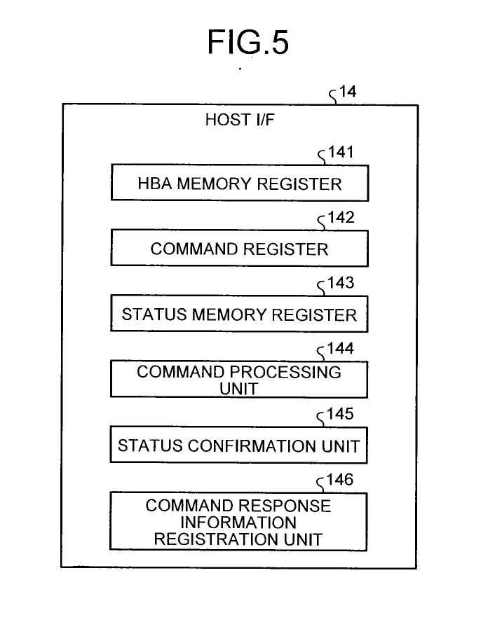

FIG. 5 is a block diagram schematically illustrating the configuration of the host interface according to the embodiment. The host interface 14 includes an HBA memory register 141, a command register 142, a status memory register 143, a command processing unit 144, a status confirmation unit 145, and a command response information registration unit 146.

The HBA memory register 141 stores a storing position in the system memory structure 300. In this case, the HBA memory register 141 stores a position in the system memory 32 in the host 30.

The command register 142 is a register that holds a command formed by transforming a command from the host 30 according to the SATA standard to be used in the non-volatile memory 11.

The status memory register 143 stores status information that indicates an execution state of a command which is issued from the host 30, on the controller 12 (non-volatile memory 11). The status information is necessary for generating command response information such as DMA Setup FIS, PIO Setup FIS, Register FIS, or Set Device Bits FIS.

When receiving an instruction of issuing a command from the host 30, the command processing unit 144 performs a process of acquiring the detail of the command based on the command list 310 in the system memory structure 300, transforming the command into a command used in the non-volatile memory 11, and registering the transformed command to the command register 142. In the case of a write command, the command processing unit 144 acquires the transfer content based on the command list 310 in the system memory structure 300, acquires the source, from which write data is acquired, in the system memory 32 from the PRDT, and transmits the write data. In the case of a read command, the command processing unit 144 acquires the transfer content based on the command list 310 in the system memory structure 300, acquires the storing destination of the read data in the system memory 32 from the PRDT, and receives the read data.

The status confirmation unit 145 performs a process of confirming the status memory register 143, and acquiring the status information that is the content of the status memory register.

The command response information registration unit 146 performs a process of creating command response information based on the status information acquired by the status confirmation unit 145, and registering the command response information 320 to the system memory structure 300. For example, the status information corresponding to the content of the Register FIS according to the SATA standard is stored in the status memory register 143 after the command is stored in the command register 142. Therefore, the command response information registration unit 146 constructs the Register FIS based on this status information, and registers the resultant to the Register FIS 323 in the command response information 320 of the system memory structure 300. The status information corresponding to the Set Device Bits FIS and the information corresponding to the DMA Setup FIS are stored in the status memory register 143 after the writing of the write data or the reading of the read data is ended. Therefore, the command response information registration unit 146 constructs the DMA Setup FIS and the Set Device Bits FIS based on the status information, and registers the resultant to the DMA Setup FIS 321 and the Set Device Bits FIS 324 in the command response information 320 of the system memory structure 300. The command response information registration unit 146 may register the DMA setup FIS to the system memory structure 300 when it is ready to process the write command or the read command in the storage device.

According to the configuration described above, full-duplex communication can be realized among the processing units in the storage device 10. For example, a response to a command, issued from the host interface 14, from the controller 12 to the host interface 14 and a transfer of write data from the host interface 14 can simultaneously be transmitted. In addition, a transfer of write data from the host interface 14 and a transfer of read data from the controller 12 (buffer 13) to the host interface 14 can simultaneously be transmitted.

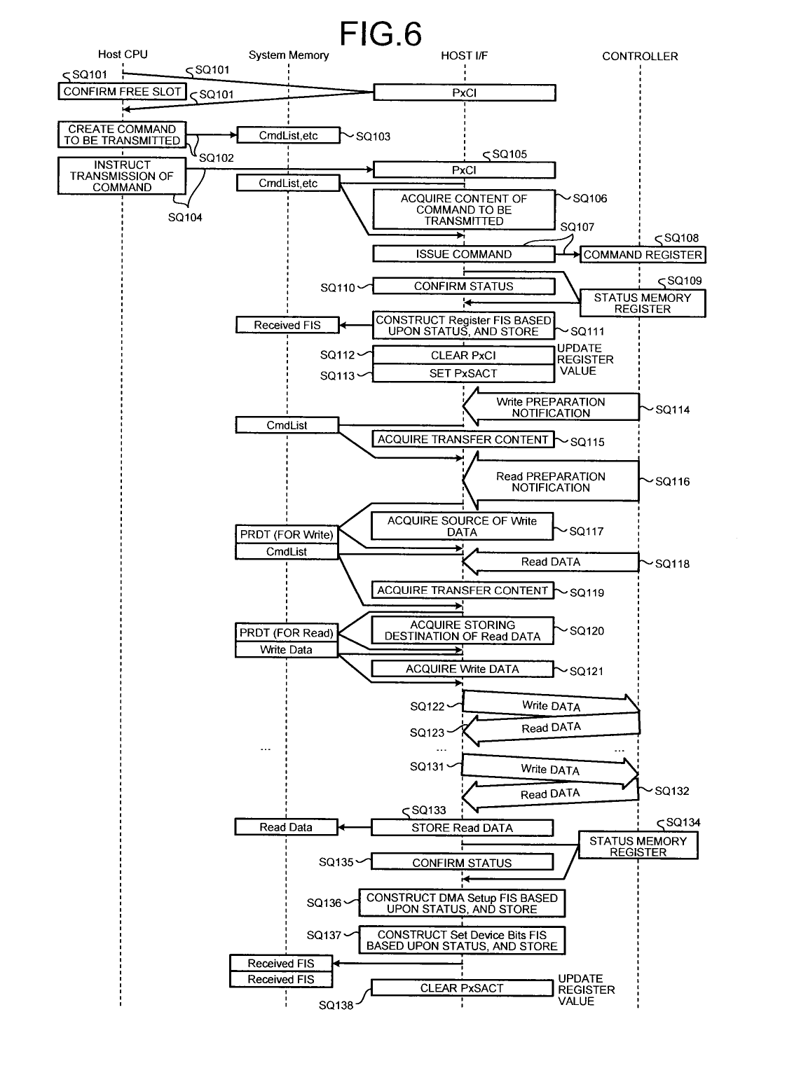

Subsequently, an operation of the information processing system according to the present embodiment will be described. FIG. 6 is a sequence diagram illustrating one example of a procedure of a data controlling method in the information processing system according to the embodiment. It is described below that an NCQ write command and an NCQ read command, which perform data transfer with queuing, are continuously issued.

The host CPU 31 in the host 30 firstly confirms whether the HBA memory register 141 in the host interface 14 of the storage device 10 has a free slot or not (SQ101). When it has a free slot, the host CPU 31 creates a command to be issued (SQ102), and registers the created command in the command list in the system memory 32 (SQ103). It is supposed here that commands are registered in the command list in the order of the NCQ write command and the NCQ read command. The NCQ write command and the NCQ read command have a format according to the SATA standard.

Then, the host CPU 31 issues an instruction of issuing the command to the host interface 14 of the storage device 10 (SQ104). With this process, a status of each of the commands to wait for the beginning of the execution is set on a PxCI register (SQ105). For example, a status of the NCQ write command to wait for the beginning of the execution is set on one P0CI register, and a status of the NCQ read command to wait for the beginning of the execution is also set on the P0CI register.

After the status of the command to wait for the beginning of the execution is set to the PxCI register, the command processing unit 144 in the host interface 14 acquires the content of the command corresponding to the set PxCI register based on the command list 310 stored on a predetermined position in the system memory 32 of the host 30 by referring to the HBA memory register 141 (SQ106). The command processing unit 144 then issues the write command and the read command to the controller 12 (SQ107).

The command processing unit 144 also transforms the issued NCQ write command and the NCQ read command into a command with a format that can be processed in the non-volatile memory 11, and registers the transformed command to the command register 142 (SQ108).

The command registered to the command register 142 is read, and sequentially executed by the controller 12, for example. When the command is executed, the status information corresponding to the FIS, which should be returned to the HBA with the SATA standard, is registered to the status memory register 143, since the command is received on a predetermined timing (SQ109).

Then, the status confirmation unit 145 in the host interface 14 acquires the status information from the status memory register 143 (SQ110). Thereafter, the command response information registration unit 146 constructs Register FIS according to the SATA standard based on the acquired status information, and stores the Register FIS constructed in the system memory 32 in the host 30 as the command response information (SQ111).

Then, the host interface 14 clears a bit of the PxCI register corresponding to the NCQ write command and the NCQ read command (SQ112), and sets a PxSACT register (SQ113).

After the preparation for the write command is made in the non-volatile memory 11, the controller 12 issues a write preparation notification (SQ114). When receiving the write preparation notification, the command processing unit 144 in the host interface 14 acquires the transfer content from the system memory 32 in the host 30 (SQ115). The command processing unit 144 also acquires the source from which the write data is acquired from the system memory 32 (SQ117). The source of the write data is acquired from the PRDT in the command table indicated by the command list 310 in the system memory structure 300.

After the preparation for the read command is made in the non-volatile memory 11, the controller 12 issues a read preparation notification (SQ116). When receiving the read preparation notification, the command processing unit 144 in the host interface 14 acquires the transfer content from the system memory 32 in the host 30 (SQ119).

The controller 12 transmits the read data from the non-volatile memory 11 (buffer 13) to the host interface 14 via the internal bus 15, in parallel with the acquisition of the source of the write data in SQ117 and the acquisition of the transfer content of the read data in SQ119 by the command processing unit 144 (SQ118). Thereafter, the command processing unit 144 acquires the storing destination of the read data from the system memory 32 in the host 30 (SQ120). The command processing unit 144 also acquires the write data, which is to be written on the non-volatile memory 11, from the system memory 32 in the host 30 (SQ121).

Then, the command processing unit 144 simultaneously executes the process of writing the acquired write data on the non-volatile memory 11 (SQ122) and the process of reading the read data from the non-volatile memory 11 (buffer 13) (SQ123). Since the internal bus 15 is configured by the transmission path that can realize the full-duplex communication in the storage device 10, the write data from the host interface 14 can be transmitted to the internal bus 15 with the read data to the host interface 14 being transmitted to the internal bus 15.

The transmission of the read data to the host interface 14 from the non-volatile memory 11 and the transmission of the write data to the non-volatile memory 11 from the host interface 14 described above are repeatedly performed (SQ131 and SQ132). Here, the read data is queued in the queuing buffer 132 from the non-volatile memory 11, and then, read to the system memory 32 in the host 30. The write data is written on the non-volatile memory 11 after being queued in the queuing buffer 13.

Then, the command processing unit 144 stores the received read data in the system memory 32 in the host 30 according to the storing destination of the read data acquired in SQ120 (SQ133). After the transfer of the read data and the storage of the write data are completed, the status information including the parameters necessary for the DMA transfer of the write data and the read data, and the status information indicating that the transfer of the write data and the read data is completed are registered to the status memory register 143 (SQ134).

The status confirmation unit 145 confirms the status memory register 143 to acquire the status information (SQ135). Then, the command response information registration unit 146 generates command response information based on the acquired status information. Specifically, the command response information registration unit 146 constructs the DMA Setup FIS from the status information including the parameters necessary for the DMA transfer of the write data and the read data, and constructs the Set Device Bits FIS from the status information indicating that the transfer of the write data and the read data is ended, as the command response information. The command response information registration unit 146 performs a process of storing these command response information into the system memory 32 in the host 30 (SQ136 to SQ137).

In the AHCI standard and the SATA standard, the host CPU 31 substantially determines the timing of confirming the command response information 320 in the system memory structure 300, and the command response information 320 is only registered to the system memory structure 300 before the timing of confirmation. Therefore, in SQ134, the status information including the parameters necessary for the DMA transfer of the write data and the read data, and the status information indicating that the transfer of the write data and the read data is ended are registered to the status memory register 143 after the process of storing the read data, and then, the DMA Setup FIS and the Set Device Bits FIS are stored in the command response information 320 in the system memory structure 300.

Since the command processing unit 144 completely ends the process designated by the PxCI register, it clears the PxSACT register (SQ138). Thus, the process is ended.

As illustrated in the sequence diagram, the handshaking communication according to the SATA standard is not performed between the host interface 14 and the controller 12 (non-volatile memory 11), but the full-duplex communication is possible. Accordingly, the write data can be transferred during the transfer of the read data.

Since the communication between the host 30 and the storage device 10 is made according to the definition of the AHCI standard and the SATA standard, it is unnecessary to change the specification of the host 30.

In the description above, the command register 142 and the status memory register 143 are provided in the host interface 14. However, they may be provided in the controller 12.

In the description above, the HBA memory register 141 indicates a position of the system memory structure 300 in the system memory 32 of the host 30. However, a part or all of the system memory structure 300 in the system memory 32 may be copied, the obtained copy may be stored in a memory provided in the host interface 14, and the storing position in the memory may be indicated. The one modified into a predetermined format to be easily used by the command processing unit 144 may be stored in the memory in the host interface 14.

According to the present embodiment, the function of the HBA is given to the host interface 14 of the storage device 10, and the processing units in the storage device 10 are connected with the internal bus 15 that enables the full-duplex communication. As a result, the present embodiment realizes the parallel operation of the reading process and the writing process in the storage device 10 and the parallel operation of the requesting process from the host 30 and the transfer process from the non-volatile memory 11 in the storage device 10, while keeping the function defined in the AHCI standard and the SATA standard with the host 30, thereby being capable of enhancing a transfer rate. The host 30 and the storage device 10 are connected with the PCIe that enables the full-duplex communication, and the processing units in the storage device 10 are connected with the internal bus 15 that enables the full-duplex communication. Therefore, the communication between the host 30 and the non-volatile memory 11 such as the NAND memory can all be made as the full-duplex communication.

Although the case where the non-volatile memory is composed of the NAND memory has been described in the embodiment described above, a magnetic disk may be used as the non-volatile memory.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing system comprising:
a host device; and
a storage device that includes a host interface communicating with the host device, a non-volatile storage unit, a controller performing a data transfer between the host interface and the storage unit, and an internal bus with which the host interface and the controller are connected based on full-duplex communication, wherein
the host interface includes a command processing unit that, when receiving an instruction of issuing a command from the host device, issues the command to the controller, and
a response to a first command from the controller and an issuance of a second command by the command processing unit are transmitted in parallel, the first command being issued to the controller from the command processing unit.

2. The information processing system according to claim 1, wherein communication between the host device and the host interface is based on PCI standard.

3. The information processing system according to claim 1, wherein
the host device includes a system memory having a command list storing a command according to AHCI standard and SATA standard, and command response information returned from the storage device by the execution of the command according to the SATA standard,
the host interface further includes an HBA memory register into which a storing position of the command list stored in the system memory is stored, and
the command processing unit reads the command list from the HBA memory register.

4. The information processing system according to claim 3, wherein the host interface further includes a command response information registration unit that generates the command response information, which is a response to the issuance of the command from the controller based on the SATA standard, on a predetermined timing after the issuance of the command by the command processing unit, and stores the generated command response information in the system memory in the host device.

5. The information processing system according to claim 4, wherein
the storage device further includes a status memory register that stores status information of the controller after the issuance of the command by the command processing unit,
the host interface further includes a status confirmation unit that acquires the status information from the status memory register, and
the command response information registration unit generates the command response information based on the status information acquired from the status memory register.

6. The information processing system according to claim 1, wherein the first command is an NCQ write command and the second command is an NCQ read command, defined by AHCI standard.

7. The information processing system according to claim 1, wherein the internal bus of the storage device includes a first path and a second path, the first path being exclusively used for a command, the second path being exclusively used for data, each of the first and second path having outgoing and incoming directions.

8. A storage device comprising:
a host interface that communicates with a host device;
a non-volatile storage unit;
a controller performing a data transfer between the host interface and the storage unit; and
an internal bus with which the host interface and the controller are connected based on full-duplex communication, wherein
the host interface includes a command processing unit that, when receiving an instruction of issuing a command from the host device, issues the command to the controller, and
a response to a first command from the controller and an issuance of a second command by the command processing unit are transmitted in parallel, the first command being issued to the controller from the command processing unit.

9. The storage device according to claim 8, wherein the host interface performs communication with the host device based on PCI standard.

10. The storage device according to claim 8, wherein
the host interface further includes an HBA memory register that stores a storing position of a command list storing a command, which is created by the host device and which conforms to AHCI standard and SATA standard, and a storing position of command response information to the execution of the command according to the SATA standard, and
the command processing unit reads command list based on the HBA memory register.

11. The storage device according to claim 10, wherein the host interface further includes a command response information registration unit that generates the command response information, which is a response to the issuance of the command from the controller based on the SATA standard, on a predetermined timing after the issuance of the command by the command processing unit, and stores the generated command response information in the system memory in the host device.

12. The storage device according to claim 11, further comprising a status memory register that stores status information of the controller after the issuance of the command by the command processing unit, wherein
the host interface further includes a status confirmation unit that acquires the status information from the status memory register, and
the command response information registration unit generates the command response information based on the status information acquired from the status memory register.

13. The storage device according to claim 8, wherein the first command is an NCQ write command and the second command is an NCQ read command, defined by AHCI standard.

14. The storage device according to claim 8, wherein the internal bus of the storage device includes a first path and a second path, the first path being exclusively used for a command, the second path being exclusively used for data, each of the first and second path having outgoing and incoming directions.

15. A controlling method of a storage device including a host interface that communicates with a host device; a non-volatile storage unit; a controller performing a data transfer between the host interface and the storage unit; and an internal bus with which the host interface and the controller are connected based on full-duplex communication, the method comprising:
issuing, when the host interface receives an instruction of issuing a first command and a second command from the host device, the first command and the second command to the controller by the host interface;
transmitting a first preparation notification of the first command to the host interface by the controller;
transmitting a second preparation notification to the second command to the host interface by the controller;
transferring first data corresponding to the first command between the host interface and the controller; and
transferring second data corresponding to the second command between the host interface and the controller in a direction reverse to the direction of the first data, wherein
the second preparation notification and the transfer of the first data are executed in parallel.

16. The controlling method according to claim 15, wherein communication between the host device and the host interface is based on PCI standard.

17. The controlling method according to claim 15, wherein, in the reading of the content of the first command and the second command, the first command list and the second command list are read based on an HBA memory register, which is created by the host device and which conforms to AHCI standard and SATA standard, and a storing position of command response information returned from the storage device by the execution of the command defined by the SATA standard.

18. The controlling method according to claim 17, further comprising:
generating the command response information, which is returned to the issuance of the command from the controller and based on the SATA standard, on a predetermined timing after the issuing of the command by the host interface; and
storing the command response information in the system memory structure of the host device by the host interface.

19. The controlling method according to claim 18, further comprising:
acquiring status information from a status memory register that stores the status information of the controller, after the issuing of the command to the controller by the host interface; and
generating the command response information based on the status information.

20. The controlling method according to claim 15, wherein the first command is an NCQ write command and the second command is an NCQ read command, defined by AHCI standard.
